(19) United States
(12) Patent Application Publication
(10) Pub. No.: US 2022/0225640 A1
(43) Pub. Date: Jul. 21, 2022

(54) Multipurpose Beverage Composition

(71) Applicant: Alexia Ramos, Washington, DC (US)

(72) Inventor: Alexia Ramos, Washington, DC (US)

(21) Appl. No.: 17/152,695

(22) Filed: Jan. 19, 2021

(51) Int. Cl. A23L 2/02; A23L 2/52; A23L 33/105; A23L 2/38; A23L 2/72

(52) U.S. Cl. CPC A23L 2/02; A23L 2/52; A23L 2/72; A23L 2/38; A23L 33/105

(57) ABSTRACT

A multipurpose beverage composition is provided, comprising a plurality of ingredients which may comprise young Thai coconut water, young Thai coconut meat, hemp hearts, Chondrus crispus, and Medjool dates. Any non-liquid ingredients of the plurality of ingredients may be combined and blended together for a first amount of time to define a first plurality of blended ingredients. Any liquid ingredients of the plurality of ingredients may be added to the first plurality of blended ingredients and blended together for a second amount of time to define a second plurality of blended ingredients. The second plurality of blended ingredients may be filtered through a strainer.

### BACKGROUND OF THE INVENTION

Human breast milk is mother nature's natural food for infant babies, but it's not always an option for every family, leaving many mothers struggling to decide what the best alternatives are for their baby or toddler. For example, some babies struggle latching to their mother's nipple, making it difficult for the baby to access the breastmilk. Some mothers struggle to produce enough breastmilk to sustain their baby or to produce any breastmilk at all. Occasionally, babies suffer from nipple confusion after a bottle is introduced too early in the baby's life. In other instances, negative aesthetic affects to the mother's body can cause the mother to choose not to breastfeed their baby. Further, some mothers have work-life balances that are imbalanced to the degree that their employment does not allow for breastfeeding beyond their allotted maternity leave and therefore force the mother to find a breastfeeding alternative.

For those mothers choosing not to personally breastfeed their babies, alternatives exist to meet the needs of such babies. For example, mothers may utilize donated breastmilk from other lactating mothers via breastmilk donation banks and the like, but such donated breastmilk is often pasteurized which destroys many of the beneficial microorganisms vital for the protection and development of the baby. Further, commercial baby formula may serve as a substitute for breastmilk, but such commercial formulas historically have contained high levels of corn syrup solids, hydrogenated oils, soybean oil, sugars and the like which are not recommended for consumption by developing babies. Additionally, commercial baby formula is known to cause digestive problems for infants and often lead to the infant purging the consumed formula or, if the infants are able to keep the formula down, they can become severely constipated.

Fortunately, the infant and toddler formula industry has evolved significantly since its inception in the early 20th century, most notably in the form of organic baby formula options. However, even these organic formulas currently on the market still contain potentially harmful ingredients such as non-fat milk, palm oil, whey protein, safflower oil, sunflower oil, brown rice syrup, non-bioavailable synthetic vitamins and the like. These ingredients often appear to mothers as harmless and perhaps even beneficial ingredients, but these ingredients have been found by some to be harmful to the development of the baby.

Another alternative available to non-breastfeeding mothers is homemade baby formula utilizing whole foods that have all essential nutrients for the baby with high levels of bioavailability to the baby's body. However, even this option has drawbacks including the monetary cost associated with sourcing these ingredients, the time cost associated with preparing the homemade formula and the quality cost associated with amateurs preparing the formula.

Therefore, a homemade formula having ingredients with high bioavailability offered in a commercial setting would be ideal. Specifically, including ingredients such as young Thai coconut water, young Thai coconut meat, hemp seeds, hemp hearts, Irish moss powder, Medjool dates and the like would be advantageous for inclusion into a baby formula. Further, preparing such nutrient-rich ingredients in a manner that allows for the highest level of bioavailability to the baby's body would be advantageous in preparing a baby formula. Further, packaging the prepared nutrient-rich ingredients in a manner that allows convenient feeding of the baby and in a manner that does not leach toxins into the formula would be advantageous.

### BRIEF DESCRIPTION OF THE DRAWINGS

FIG. 1 illustrates a flow diagram of a process of producing a multipurpose beverage composition in accordance with some embodiments of the present invention.

### DETAILED DESCRIPTION OF THE INVENTION

Before describing the present invention in detail, it is to be understood that the invention is not limited to any one of the particular embodiments, which of course may vary. It is also to be understood that the terminology used herein is for the purpose of describing particular embodiments only, and therefore is not necessarily intended to be limiting. As used in this specification and the appended claims, terms in the singular and the singular forms “a,” “an,” and “the” include plural referents unless the context clearly dictates otherwise. Thus, for example, reference to “a multipurpose beverage composition” also includes a plurality of multipurpose beverage compositions and the like.

In some embodiments, a multipurpose beverage composition is provided, comprising a plurality of ingredients, comprising young Thai coconut water; young Thai coconut meat; hemp hearts; Chondrus crispus; and Medjool dates.

In some embodiments, the young Thai coconut meat comprises coconut shavings, desiccated coconut, raw coconut flesh or any combination thereof, and wherein the Medjool dates comprise date paste, date sugar, date syrup or any combination thereof.

In some embodiments, the plurality of ingredients further comprises water.

In some embodiments, one or more of the plurality of ingredients are utilized in whole form, chopped form, diced form, shredded form, crushed form, desiccated form, ground form, powdered form, baked form, toasted form, blended form, pulverized form, juiced form or any combination thereof.

In some embodiments, the plurality of ingredients further comprises one or more of spirulina, broccoli sprouts, chlorella, Sacha Inchi seeds, kefir and bladderwrack.

In some embodiments, the plurality of ingredients are selected from an ingredient menu by an end consumer.

In some embodiments, the ingredient menu is accessed by the end consumer through a graphical user interface.

In some embodiments, each of the plurality of ingredients selected from the ingredient menu by the end consumer are further selected by the end consumer to be in one or more of whole form, chopped form, diced form, shredded form, crushed form, desiccated form, ground form, powdered form, baked form, toasted form, blended form, pulverized form or juiced form.

In some embodiments, selection of the plurality of ingredients from the ingredient menu by the end consumer initiates delivery of the selected ingredients to the end consumer.

In some embodiments, non-liquid ingredients of the plurality of ingredients are combined and blended together for a first amount of time to define a first plurality of blended ingredients, and wherein liquid ingredients of the plurality of ingredients are added to the first plurality of blended ingredients and blended together for a second amount of time to define a second plurality of blended ingredients.

In some embodiments, the second plurality of blended ingredients are filtered through a strainer.

In some embodiments, the strainer comprises a pore diameter of no greater than 0.125 inches.

In some embodiments, a multipurpose beverage composition is provided, comprising a plurality of ingredients, comprising: young Thai coconut water; young Thai coconut meat; hemp hearts; Chondrus crispus; and Medjool dates; wherein the plurality of ingredients are combined and blended together for a first amount of time to define a first plurality of blended ingredients, and wherein the first plurality of blended ingredients are filtered through a strainer.

In some embodiments, non-liquid ingredients of the plurality of ingredients are combined and blended together for the first amount of time to define the first plurality of blended ingredients, wherein liquid ingredients of the plurality of ingredients are added to the first plurality of blended ingredients and blended together for a second amount of time to define a second plurality of blended ingredients that are then filtered through the strainer.

In some embodiments, a multipurpose beverage composition is provided, comprising a plurality of ingredients, comprising: young Thai coconut water; young Thai coconut meat; hemp hearts; Chondrus crispus; and Medjool dates; wherein non-liquid ingredients of the plurality of ingredients are combined and blended together for a first amount of time to define a first plurality of blended ingredients, wherein liquid ingredients of the plurality of ingredients are added to the first plurality of blended ingredients and blended together for a second amount of time to define a second plurality of blended ingredients, wherein the second plurality of blended ingredients are filtered through a strainer having a pore diameter of no greater than 0.125 inches.

In some embodiments, the filtered second plurality of blended ingredients are packaged into a thermally robust container.

In some embodiments, the thermally robust container comprises a threaded aperture having dimensions to accept a threaded screw cap of a baby bottle nipple.

Additional exemplary embodiments of the present invention are described in this and proceeding paragraphs. A multipurpose beverage composition is provided. The beverage composition may comprise a plurality of ingredients, where each of the plurality of ingredients may have one or more substitute or additive ingredients. Further, the plurality of ingredients may be incorporated into the beverage composition in a range of acceptable quantities. Additionally, the plurality of ingredients may be incorporated into the beverage composition in any suitable form or consistency.

The plurality of ingredients contained within the multipurpose beverage composition may comprise, but are not limited to, coconut water, young Thai coconut water, coconut milk, young Thai coconut milk, spring water, almond milk, hemp milk, banana milk, rice milk, oat milk and the like or any combination thereof. For purposes of producing a substantially liquid composition, it is necessary to include one or more liquid ingredients in a quantity sufficient to produce the substantially liquid composition after combining, blending and filtering as described herein. While any one or more of the previously listed primarily liquid ingredients may be utilized in the multipurpose beverage composition, those associated with young Thai coconuts are preferable and advantageous to utilize beyond the other listed ingredients. Specifically, while fully ripened coconuts are typically utilized for their higher yield of meat, water and/or milk, such coconuts are not ideal for the intended purposes of a breastmilk and/or baby formula alternative, a pre/post workout drink nor a meal replacement. While yielding lower amounts of meat, water and/or milk, younger more unripened coconuts are unexpectedly preferable to use given their meat is lower in fat and higher in calcium than the more ripened alternative. Further, young Thai coconuts provide even lower levels of fat in their meat and higher levels of calcium than other young coconuts. Additionally, young Thai coconuts provide medium-chain fatty acids that have higher bioavailability to the human body than other fully ripened coconuts and other young coconut varieties. Further, young Thai coconuts provide greater anti-inflammatory benefits to the human body than fully ripened coconuts and other young coconut varieties.

While young Thai coconut water or young Thai coconut milk may be incorporated by percentage into the multipurpose beverage composition in any suitable quantity, the preferred content by percentage of young Thai coconut water or young Thai coconut milk is between 15 percent and 75 percent, more preferably between 25 percent and 65 percent, and most preferably between 35 percent and 55 percent. Specifically, the range of between 35 percent and 55 percent provides for an end product of the multipurpose beverage composition that has at least a semi-liquid consistency typically desired in a product labeled as a beverage. Further, the range of between 35 percent and 55 percent allows for adequate coconut-based nutrition to be supplied to an end consumer given typical serving sizes. Additionally, ranges below 15 percent produce an end product that is not liquid enough for a beverage while ranges above 75 percent do not allow for enough of the nutrients found in the other of the plurality of ingredients comprised within the multipurpose beverage composition.

The plurality of ingredients contained within the multipurpose beverage composition may comprise, but are not limited to, coconut meat, coconut flakes, coconut shavings, desiccated coconut, raw coconut meat, frozen coconut meat, young Thai coconut meat and the like or any combination thereof. While any one or more of the previously listed ingredients may be utilized in the multipurpose beverage composition, those associated with young Thai coconuts are preferable and advantageous to utilize beyond the other listed ingredients for reasons explained in the preceding paragraph. Additionally, despite young Thai coconuts producing less meat than other fully ripened coconuts and other young coconut varieties, young Thai coconuts are still unexpectedly the preferred ingredient to utilize given the beneficial properties of the young Thai coconut meat described in the preceding paragraph.

While young Thai coconut meat may be incorporated by percentage into the multipurpose beverage composition in any suitable quantity, the preferred content by percentage of young Thai coconut meat is between 5 percent and 55 percent, more preferably between 10 percent and 45 percent, and most preferably between 15 percent and 35 percent. Specifically, the range of between 15 percent and 35 percent provides for an end product of the multipurpose beverage composition that has at least a semi-liquid consistency typically desired in a product labeled as a beverage. Further, the range of between 35 percent and 55 percent allows for adequate coconut-based nutrition to be supplied to an end consumer given typical serving sizes. Additionally, ranges below 5 percent produce an end product that does not contain enough of the medium-chain fatty acids found in the young Thai coconut meat while ranges above 55 percent produce an end product that is not liquid enough for a beverage.

The plurality of ingredients contained within the multipurpose beverage composition may comprise, but are not limited to, hemp seed, hemp hearts, flax seed, chia seed, sunflower kernel, pine nut and the like or any combination thereof. For purposes of producing a multipurpose beverage composition that is nutritionally well-balanced to serve as a breastmilk or meal replacement, it is necessary to include one or more highly fibrous and protein-rich ingredients in a quantity sufficient to sustain the human body at any stage of development. While any one or more of the previously listed ingredients may be utilized in the multipurpose beverage composition, those associated with hemp seeds and hemp hearts are preferable. While other ingredients previous listed may be more easily sourced and processed, hemp seeds and hemp hearts are unexpectedly the preferred ingredient to utilize given their adequate levels of protein and fiber, ability to balance hormones within the human body, abundant levels of necessary fatty acids and their ability to combat various skin disorders and hypertension that may plague the human body throughout all stages of development.

While hemp seeds and hemp hearts may be incorporated by percentage into the multipurpose beverage composition in any suitable quantity, the preferred content by percentage of hemp seeds and hemp hearts is between 5 percent and 25 percent, more preferably between 5 percent and 20 percent, and most preferably between 5 percent and 15 percent. Specifically, the range of between 5 percent and 15 percent provides for an end product of the multipurpose beverage composition that has an adequate amount of protein, fiber and fatty acids that are necessary nutrients for human development given typical serving sizes. Additionally, ranges above 25 percent produce an end product that is not liquid enough for a beverage.

The plurality of ingredients contained within the multipurpose beverage composition may comprise, but are not limited to, Irish moss powder, kelp, seaweed, seamoss, chlorella, spirulina, seamoss gel and the like or any combination thereof. For purposes of producing a multipurpose beverage composition that is nutritionally well-balanced to serve as a breastmilk or meal replacement, it is necessary to include one or more mineral-rich and nutrient-dense ingredients in a quantity sufficient to sustain the human body at any stage of development. While any one or more of the previously listed ingredients may be utilized in the multipurpose beverage composition, those associated with Chondrus crispus or Irish seamoss are preferable. Despite not having the most palatable flavor, Chondrus crispus or Irish seamoss are unexpectedly the preferred ingredient to utilize given they provide 92 of the 102 minerals necessary for healthy development of the human body. Further, they are preferred in the uses of breastmilk alternatives and meal replacements as they sooth the membranes of the digestive tract, are low in calories, enhance the production of hair, skin and nails, promote a healthy thyroid and metabolic cycle while providing antioxidants to combat free radicals that can lead to various cancers and diseases.

While Chondrus crispus or Irish seamoss may be incorporated by percentage into the multipurpose beverage composition in any suitable quantity, the preferred content by percentage of Chondrus crispus or Irish seamoss is between 1 percent and 20 percent, more preferably between 1 percent and 15 percent, and most preferably between 1 percent and 10 percent. Specifically, the range of between 1 percent and 10 percent provides for an end product of the multipurpose beverage composition that provides an adequate amount of the necessary minerals for human development given typical serving sizes. Ranges above 20 percent produce an end product that contains much more of the necessary nutrients than is required and further renders the beverage less palatable given the generally unpalatable taste of the Chondrus crispus or Irish seamoss.

The plurality of ingredients contained within the multipurpose beverage composition may comprise, but are not limited to, dates, Medjool dates, date sugar, date syrup, figs, raisins, craisins, cherries, apricots, prunes and the like or any combination thereof. For purposes of producing a multipurpose beverage composition that is nutritionally well-balanced to serve as a breastmilk or meal replacement while also providing a pleasing consistency to consume, it is necessary to include one or more mineral-rich and nutrient-dense ingredients that also provides a palatable taste and thick creamy consistency. While any one or more of the previously listed ingredients may be utilized in the multipurpose beverage composition, those associated with Medjool dates are preferable. While more difficult to process and incorporate into a beverage given their inner pits and high levels of fiber, Medjool dates are still unexpected the preferred ingredient to utilize given their relatively high levels of selenium, magnesium, calcium, potassium and copper. Further, even relative other dates, Medjool dates in particular provide a high level of phytonutrients that stimulate the immune system, reduce inflammation, prevent DNA damage and improve hormone regulation. Additionally, the high level of fiber in the Medjool date is advantageous in that is provides a high level of refined fiber even after being blended which is unexpected given most fruits lose their nutritional fiber upon blending into an alternative consistency.

While Medjool dates may be incorporated by percentage into the multipurpose beverage composition in any suitable quantity, the preferred content by percentage of Medjool dates is between 10 percent and 30 percent, more preferably between 10 percent and 25 percent, and most preferably between 10 percent and 20 percent. Specifically, the range of between 10 percent and 20 percent provides for an end product of the multipurpose beverage composition having a rich, thick and creamy consistency that is desired in a meal-replacement beverage. Ranges above 30 percent produce an end product that is too thick to be enjoyed by an end consumer as a beverage.

The plurality of ingredients contained within the multipurpose beverage composition may additionally comprise, but are not limited to, spirulina, broccoli sprouts, chlorella, Sacha Inchi seeds, kefir, bladderwrack and the like or any combination thereof. The inclusion of such ingredients may be additive or substitute in nature and can serve to provide nutrient-dense, mineral-rich and low-calorie organic ingredients found in nature that can be selectively utilized by an end consumer based upon their specific nutrient and mineral deficiencies, thereby making the multipurpose beverage composition a more widely applicable product to end consumers of varying need.

Each of the plurality of ingredients may be incorporated into the multipurpose beverage composition in any suitable form such as, but not limited to, whole, chopped, diced, shredded, crushed, desiccated, ground, powdered, baked, toasted, blended, pulverized, juiced and the like or any combination thereof. Such diversity of form allows for the multipurpose beverage composition to be made available to a wider range of users including, but not limited to, infants, babies, children, teenagers, adults, elderly and the like or any of the aforementioned participating in a diet such as, but not limited to, a vegan diet, a vegetarian diet, an organic diet, a paleo diet, a gluten-free diet, a weight-loss diet, a low-carbohydrate diet and the like or any combination thereof.

For example, an infant user whose mother chooses to feed the infant a breastmilk-alternative may utilize the plurality of ingredients of the multipurpose beverage composition in a formula mix configuration where the plurality of ingredients are dehydrated in a desiccated, ground and/or powdered form. This configuration allows the multipurpose beverage composition to be stored in a bulk container that is accessed per each serving and only requires the mother to add spring water to each serving in order to prepare the multipurpose beverage composition for consumption. Such a configuration of the multipurpose beverage composition allows for the mother to store large quantities of the composition for a long period of time in a safe manner while still being able to meet the nutritional demands of the infant.

In another example, an adult user participating in a vegetarian diet may utilize the plurality of ingredients of the multipurpose beverage composition in a ready-to-consume configuration where the plurality of ingredients are hydrated in an at least partially liquid form. This configuration allows individual servings of the multipurpose beverage composition to be stored in respective single-serving containers and only requires the adult user to open the single-serving container in order to consume the single serving of contents therein. Given that the adult user is not reliant upon the multipurpose beverage composition for daily nourishment like an infant user but rather may diversify their diet, the single-serving containers are advantageous for the adult user participating in the vegetarian diet so as to allow the adult user the option of choosing when to consume one or more single servings of the multipurpose beverage composition. The shelf-life of such a configuration is shorter than that of the desiccated, ground and/or powdered configuration, but convenience and ease of consumption is increased in the ready-to-consume configuration. Further, the lowered shelf-life may be compensated for by the adult user's ability to purchase as many single-serving containers as required before expiration of the plurality of ingredients therein.

In another example, an elderly user participating in a weight-loss diet may utilize the plurality of ingredients of the multipurpose beverage composition in a home-prep configuration where the plurality of ingredients are delivered to the elderly user in whole form. This configuration allows the elderly user to utilize the plurality of ingredients in any manner desired according to any recipe or formula selected by the elderly user. The plurality of ingredients in whole form provide the elderly user with the maximum nutrition therefrom and the maximum freedom to consume the plurality of ingredients within the multipurpose beverage composition in the manner desired. While shelf-life of the plurality of ingredients is reduced in the home-prep configuration relative other configurations, nutrition and freedom of preparation are increased in this configuration. The reduced shelf-life may be compensated for by the elderly user's ability to have delivered only the amount of the plurality of ingredients as required before expiration of those ingredients. Further, successive deliveries of the plurality of ingredients to the elderly user may be scheduled to arrive in an iterative periodic manner.

In another example, a breastfeeding mother not participating in any particular diet may utilize the plurality of ingredients of the multipurpose beverage composition in each of the formula mix configuration, the ready-to-consume configuration and the home-prep configuration. The formula mix configuration allows the breastfeeding mother an alternative to breastfeeding their infant child which may be selectively implemented as the mother sees fit.

For example, after exclusively breastfeeding the child, the mother may eventually choose to begin slowly weening the child off of breast milk. The long shelf-life of the formula mix configuration provides a great deal of flexibility for the mother to accomplish a slow ween off of breast milk without allowing the plurality of ingredients to perish. During the initial stages of such a slow ween, the ready-to-consume configuration and home-prep configuration may be utilized during the shorter shelf-life of these configurations. Alternatively, the mother herself may consume the ready-to-consume configuration and the home-prep configuration in addition to feeding these to her infant child, thus further reducing the likelihood that these configurations will perish beyond their respective shelf-lives.

Further, in another example, any one of the aforementioned exemplary users may select between the formula mix configuration, the ready-to-consume configuration and the home-prep configuration via a menu selection platform. For instance, the menu selection platform may be implemented as a software application and accessible by the user via a graphical user interface on desktop computers, tablets, smartphones and other personal electronic devices. Alternatively, the menu selection platform may be implemented in physical media such as a postcard and accessible by the user via the mail system.

Additionally, any one of the aforementioned exemplary users may select between a list of the plurality of ingredients displayed on the menu selection platform. Specifically, the user may select one or more ingredients from each of a plurality of ingredient buckets within the list displayed on the menu selection platform. Each ingredient bucket may comprise a plurality of ingredients that fall under the same or similar categories of consistency, texture, nutrition, bioavailability and the like or any combination thereof. One or more of the plurality of ingredient buckets may be listed as ‘optional’ within the menu selection platform to successfully constituting the multipurpose beverage composition. One or more of the plurality of ingredient buckets may be listed as ‘required’ within the menu selection platform to successfully constituting the multipurpose beverage composition.

For instance, a first ingredient bucket may include young Thai coconut water, young Thai coconut milk, spring water, almond milk, hemp milk, banana milk, rice milk, oat milk and the like or any combination thereof. A second ingredient bucket may include young Thai coconut meat, coconut flakes, coconut shavings, desiccated coconut, raw coconut meat, frozen coconut meat, young coconuts and the like or any combination thereof. A third ingredient bucket may include hemp seed, hemp hearts, flax seed, chia seed, sunflower kernel, pine nut and the like or any combination thereof. A fourth ingredient bucket may include Chondrus crispus, Irish moss powder, kelp, seaweed, seamoss, chlorella, spirulina, seamoss gel and the like or any combination thereof. A fifth ingredient bucket may include Medjool dates, date sugar, date syrup, figs, raisins, craisins, cherries, apricots, prunes and the like or any combination thereof. A sixth ingredient bucket may include spirulina, broccoli sprouts, chlorella, Sacha Inchi seeds, kefir, bladderwrack and the like or any combination thereof.

Further, the menu selection platform may allow a user to choose a desired form or consistency for each of the plurality of ingredients selected from the menu selection platform. Menu selections for the desired form or consistency of each of the plurality of ingredients may include, but is not limited to, whole, chopped, diced, shredded, crushed, desiccated, ground, powdered, baked, toasted, blended, pulverized, juiced and the like or any combination thereof. For example, if the user selects coconut meat from an ingredient bucket, then the menu selection platform may offer the user the choice to select the desired form or consistency in which to receive the selected coconut meat.

Additionally, upon the user selecting a plurality of ingredients from the plurality of ingredient buckets displayed upon the menu selection platform, the user may then be allowed to select one or more delivery options. For instance, the one or more delivery options may include, but are not limited to, a delivery method, a delivery timeframe, a delivery schedule, a delivery repetition and the like or any combination thereof.

The multipurpose beverage composition may be processed for consumption in a particular manner according to the configuration selected by the user. For example, if the user selects the formula mix configuration, then the multipurpose beverage composition may take a powdered form or consistency. In order to prepare the powdered formula mix for consumption, the user may combine the powdered formula mix with one or more ingredients from the first ingredient bucket including, but not limited to, coconut water, coconut milk, spring water, almond milk, hemp milk, banana milk, rice milk, oat milk and the like or any combination thereof. Additionally, stirring and/or heat may be applied to the combined mixture in order to constitute a final consumable beverage composition.

Prior to sale of the formula mix configuration, processing of the plurality of ingredients to constitute the formula mix configuration may begin by obtaining the selected plurality of ingredients in whole form. Each of the whole ingredients, except purely liquid ingredients, may be blended, food-processed, pureed or the like for a first amount of time such that the whole ingredients are rendered into semi-liquid form. After being rendered into semi-liquid form, the purely liquid ingredients may be added thereto and the resulting mixture may be blended, food-processed, pureed or the like for a second amount of time such that the semi-liquid ingredients are rendered into substantially liquid ingredients.

The substantially liquid ingredients may then be filtered through a strainer having a threshold pore diameter that collects any non-liquid ingredients and passes only liquid ingredients therethrough. After this filtering process, the liquid ingredients may be dehydrated into substantially powdered form using any suitable dehydration process. Thereafter, the resulting powered ingredients may constitute the formula mix configuration which may be secured within any suitable packaging container that is designed to robustly retain and dispense powdered contents.

In the formula mix configuration, a suitable packaging container may be non-toxic, BPA-free, microwave-safe, freezer-safe and the like or any combination thereof. Specific examples of packaging containers that may be utilized with the formula mix configuration include, but are not limited to, glass containers, Mason jars, paper-based cartons, aluminum cans and the like or any combination thereof. Further, the packaging container may comprise an interior and/or exterior lining made from a petroleum-based plastic coating or a sugar-based bio-ethanol derived low-density polyethylene plastic coating.

Additionally, the formula mix configuration may be stored in such a packaging container but may be prepared in an alternative container. Specifically, the alternative preparation container must be robust to application of thermal energy and microwave use. Further, the alternative preparation container may comprise a threaded aperture shaped to conform to universal baby bottle sizes to accommodate baby bottle nipples for use in breastfeeding alternatives with organic formula. An associated screw cap may be utilized to seal and store the prepared formula mix and may be replaced by the screw cap baby bottle nipple during use.

In another example, if the user selects the ready-to-consume configuration, then the multipurpose beverage composition may be preprocessed before sale to the user to constitute the final consumable beverage composition. Specifically, the processing may begin by obtaining the selected plurality of ingredients in whole form. Each of the whole ingredients, except purely liquid ingredients, may be blended, food-processed, pureed or the like for a first amount of time such that the whole ingredients are rendered into semi-liquid form. After being rendered into semi-liquid form, the purely liquid ingredients may be added thereto and the resulting mixture may be blended, food-processed, pureed or the like for a second amount of time such that the semi-liquid ingredients are rendered into substantially liquid ingredients.

The substantially liquid ingredients may then be filtered through a strainer having a threshold pore diameter that collects any non-liquid ingredients and passes only liquid ingredients therethrough. After this filtering process, the liquid ingredients may be secured within any suitable packaging container that is designed to robustly retain and conveniently dispense liquids.

In the ready-to-consume configuration, a suitable packaging container may be non-toxic, BPA-free, microwave-safe, freezer-safe and the like or any combination thereof. Specifically, such a suitable packaging container must be robust to application of thermal energy and microwave use. Further, the packaging container may comprise a threaded aperture shaped to conform to universal baby bottle sizes to accommodate baby bottle nipples for use in breastfeeding alternatives with organic formula. An associated screw cap may be utilized to seal and store the prepared formula mix and may be replaced by the screw cap baby bottle nipple during use.

In another example, if the user selects the home-prep configuration, then the multipurpose beverage composition may be processed at home upon the user obtaining the whole ingredients at their residence. Specifically, each of the whole ingredients, except purely liquid ingredients, may be blended, food-processed, pureed or the like for a first amount of time such that the whole ingredients are rendered into semi-liquid form. After being rendered into semi-liquid form, the purely liquid ingredients may be added thereto and the resulting mixture may be blended, food-processed, pureed or the like for a second amount of time such that the semi-liquid ingredients are rendered into substantially liquid ingredients.

The substantially liquid ingredients may then be filtered through a strainer having a threshold pore diameter that collects any non-liquid ingredients and passes only liquid ingredients therethrough. After this filtering process, the liquid ingredients may be secured within any suitable container that is conducive to holding and consuming the liquid ingredients.

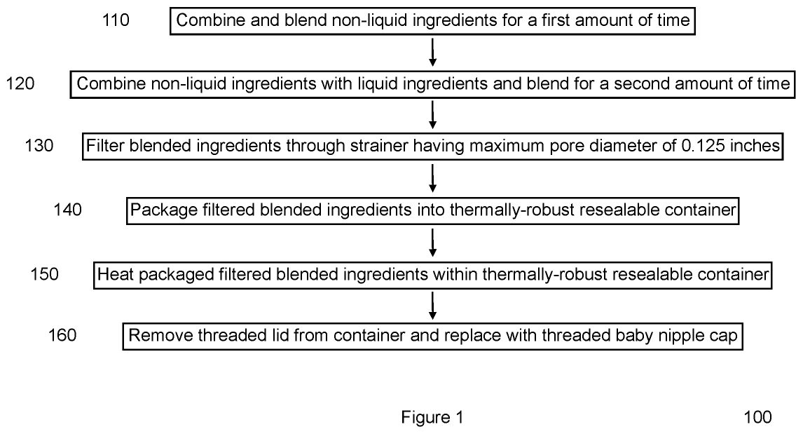

As illustrated in FIG. 1, a method 100 of producing a multipurpose beverage composition is provided. The method 100 comprises step 110 of combining all non-liquid ingredients together and blending them for a first amount of time. The first amount of time may be a suitable amount of time for the non-liquid ingredients to turn into a semi-liquid blended mixture. For example, the first amount of time may be within a range of between 10 seconds and 90 seconds, but preferably between 20 seconds and 70 seconds, and more preferably between 30 seconds and 50 seconds. The range of between 30 seconds and 50 seconds allows enough time for the non-liquid ingredients to turn into the semi-liquid blended mixture but is not overly burdensome in requiring too much time to process. Ranges beyond 90 seconds provide severely diminishing returns in refining the non-liquid ingredients into the semi-liquid blended mixture. Ranges less than 10 seconds do not provide enough time to create the semi-liquid blended mixture.

Examples of non-liquid ingredients may include, but are not limited to, coconut meat, coconut flakes, coconut shavings, desiccated coconut, raw coconut meat, frozen coconut meat, young Thai coconuts, hemp seed, hemp hearts, flax seed, chia seed, sunflower kernel, pine nut, Chondrus crispus, Irish moss powder, kelp, seaweed, seamoss, chlorella, spirulina, seamoss gel, Medjool dates, date sugar, date syrup, figs, raisins, craisins, cherries, apricots, prunes, spirulina, broccoli sprouts, chlorella, Sacha Inchi seeds, kefir, bladderwrack and the like or any combination thereof.

The method 100 further comprises step 120 of combining the now semi-liquid blended mixture with any remaining liquid ingredients and blending together for a second amount of time. The second amount of time may be a suitable amount of time for the semi-liquid blended mixture to combine with the liquid ingredients and further allow the blending to reduce the semi-liquid blended mixture into a substantially liquid blended mixture. For example, the second amount of time may be within a range of between 30 seconds and 120 seconds, but preferably between 45 seconds and 90 seconds, and more preferably between 60 seconds and 75 seconds. The range of between 60 seconds and 75 seconds allows enough time for the semi-liquid blended mixture to turn into the substantially liquid blended mixture but is not overly burdensome in requiring too much time to process. Ranges beyond 120 seconds provide severely diminishing returns in refining the semi-liquid blended mixture into the substantially liquid blended mixture. Ranges less than 30 seconds do not provide enough time to create the substantially liquid blended mixture. Ranges between 75 seconds and 120 seconds may be utilized if it is desired to reduce the more fibrous portions of the non-liquid ingredients into the substantially liquid blended mixture. Examples of liquid ingredients may include, but are not limited to, coconut water, young Thai coconut water, coconut milk, young Thai coconut milk, spring water, almond milk, hemp milk, banana milk, rice milk, oat milk and the like or any combination thereof.

The method 100 further comprises step 130 of filtering the substantially liquid blended mixture through a strainer having a maximum pore diameter of 0.125 inches. Step 130 is crucial to producing an end product of the multipurpose beverage composition that is safely consumable without any large fibrous elements from the non-liquid ingredients being in the end product that might cause an end consumer to choke or experience discomfort during consumption. The pore diameter of the strainer is selected to be a maximum of 0.125 inches so as to allow the highly nutritious refined fibrous material from the non-liquid ingredients to be utilized in the end product, but such a pore diameter does not allow the potentially unsafe unrefined fibrous material from the non-liquid ingredients to pass into the end product. Utilizing strainers having a pore diameter above 0.125 inches will increase the likelihood that potentially harmful unrefined fibrous material passes into the end product. However, as the selected pore diameter decreases below 0.125 inches, the effect will proportionally increase the refined silky characteristics of the consistency of the end product of the multipurpose beverage composition. The tradeoff for choosing a pore diameter significantly below 0.125 would be the elimination of highly nutritious refined fibrous material from the non-liquid ingredients. The end consumer may be allowed to choose their own straining pore diameter to select their desired characteristics of the multipurpose beverage composition.

The method 100 further comprises step 140 of packaging the filtered end product into a thermally-robust resealable container. In this sense, the thermally-robust resealable container may be any suitable container that is non-toxic, BPA-free, microwave-safe, freezer-safe and the like or any combination thereof. Exemplary containers may include, but are not limited to, glass containers, plastic containers, metal containers, cardboard containers, containers having interior protective linings and the like or any combination thereof. Thermally-robust refers to the container being structurally and chemically robust to repeated exposure to thermal energy, electromagnetic energy, ultrasonic energy and the like or any combination thereof. Further, the resealable container may comprise a threaded aperture disposed at an outlet pouring aperture of the container. This threaded aperture may allow for a lid of the container to be removed and replaced as the end consumer desires. Further, the threaded aperture may have a form factor that is of an industry standard for accepting attachment of threaded baby nipple caps and the like.

The method 100 further comprises step 150 of heating the packaged filtered end product within the thermally-robust resealable container. Step 150 may be optionally applied by the end consumer as the end product may be safely consumed without application of heat. Further, the end consumer may heat the end product to any desired consumption temperature. The method further comprises step 160 of removing the threaded lid from the container and replacing it with a threaded baby nipple cap or the like. Step 160 may be optionally applied by the end consumer depending upon the desired use of the multipurpose beverage composition. Allowing the container to readily accept application of a threaded baby nipple cap allows the container and multipurpose beverage composition to be easily utilized by an end consumer as a baby formula alternative.

The specification and drawings are to be regarded in an illustrative rather than a restrictive sense. However, it will be evident that various modifications and changes may be made thereunto without departing from the broader spirit and scope of the invention as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a,” “an,” “the,” and similar referents in the context of describing the disclosed embodiments (especially in the context of the following claims) are to be construed to cover both the singular and the plural, unless otherwise indicated or clearly contradicted by context. The terms “comprising,” “having,” “including,” and “containing” are to be construed as open-ended terms (i.e., meaning “including, but not limited to,”) unless otherwise noted. The term “connected,” where unmodified and referring to physical connections, is to be construed as partly or wholly contained within, attached to, or joined together, even if there is something intervening. Recitation of ranges of values are merely intended to serve as a shorthand method of referring individually to each separate value falling within the range, unless otherwise indicated and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal.

Conjunctive language, such as phrases of the form “at least one of A, B, and C,” or “at least one of A, B and C,” is understood with the context as used in general to present that an item, term, etc., may be either A or B or C, or any nonempty subset of the set of A and B and C, unless specifically stated otherwise or otherwise clearly contradicted by context. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). The number of items in a plurality is at least two, but can be more when so indicated either explicitly or by context.

The use of any examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described, including the best mode known to the inventors for carrying out the invention. Variations of those embodiments may become apparent to those of ordinary skill in the art upon reading the foregoing description. The inventors expect skilled artisans to employ such variations as appropriate and the inventors intend for embodiments of the present disclosure to be practiced otherwise than as specifically described. Accordingly, the scope of the present disclosure includes all modifications and equivalents of the subject matter recited in the claims appended hereto as permitted by applicable law. Moreover, although above-described elements may be described in the context of certain embodiments of the specification, unless stated otherwise or otherwise clear from context, these elements are not mutually exclusive to only those embodiments in which they are described; any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A multipurpose beverage composition, comprising:
a plurality of ingredients, comprising:
young Thai coconut water;
young Thai coconut meat;
hemp hearts;
Chondrus crispus; and
Medjool dates.

2. The multipurpose beverage composition of claim 1, wherein the young Thai coconut meat comprises coconut shavings, desiccated coconut, raw coconut flesh or any combination thereof, and wherein the Medjool dates comprise date paste, date sugar, date syrup or any combination thereof.

3. The multipurpose beverage composition of claim 1, wherein the plurality of ingredients further comprises water.

4. The multipurpose beverage composition of claim 1, wherein one or more of the plurality of ingredients are utilized in whole form, chopped form, diced form, shredded form, crushed form, desiccated form, ground form, powdered form, baked form, toasted form, blended form, pulverized form, juiced form or any combination thereof.

5. The multipurpose beverage composition of claim 1, wherein the plurality of ingredients further comprises one or more of spirulina, broccoli sprouts, chlorella, Sacha Inchi seeds, kefir and bladderwrack.

6. The multipurpose beverage composition of claim 5, wherein the plurality of ingredients are selected from an ingredient menu by an end consumer.

7. The multipurpose beverage composition of claim 6, wherein the ingredient menu is accessed by the end consumer through a graphical user interface.

8. The multipurpose beverage composition of claim 6, wherein each of the plurality of ingredients selected from the ingredient menu by the end consumer are further selected by the end consumer to be in one or more of whole form, chopped form, diced form, shredded form, crushed form, desiccated form, ground form, powdered form, baked form, toasted form, blended form, pulverized form or juiced form.

9. The multipurpose beverage composition of claim 6, wherein selection of the plurality of ingredients from the ingredient menu by the end consumer initiates delivery of the selected ingredients to the end consumer.

10. The multipurpose beverage composition of claim 1, wherein non-liquid ingredients of the plurality of ingredients are combined and blended together for a first amount of time to define a first plurality of blended ingredients, and wherein liquid ingredients of the plurality of ingredients are added to the first plurality of blended ingredients and blended together for a second amount of time to define a second plurality of blended ingredients.

11. The multipurpose beverage composition of claim 10, wherein the second plurality of blended ingredients are filtered through a strainer.

12. The multipurpose beverage composition of claim 11, wherein the strainer comprises a pore diameter of no greater than 0.125 inches.

13. A multipurpose beverage composition, comprising:
a plurality of ingredients, comprising:
young Thai coconut water;
young Thai coconut meat;
hemp hearts;
Chondrus crispus; and
Medjool dates;
wherein the plurality of ingredients are combined and blended together for a first amount of time to define a first plurality of blended ingredients, and wherein the first plurality of blended ingredients are filtered through a strainer.

14. The multipurpose beverage composition of claim 13, wherein non-liquid ingredients of the plurality of ingredients are combined and blended together for the first amount of time to define the first plurality of blended ingredients, wherein liquid ingredients of the plurality of ingredients are added to the first plurality of blended ingredients and blended together for a second amount of time to define a second plurality of blended ingredients that are then filtered through the strainer.

15. The multipurpose beverage composition of claim 14, wherein the strainer comprises a pore diameter of no greater than 0.125 inches.

16. The multipurpose beverage composition of claim 13, wherein the plurality of ingredients further comprises one or more of spirulina, broccoli sprouts, chlorella, Sacha Inchi seeds, kefir and bladderwrack.

17. The multipurpose beverage composition of claim 16, wherein the plurality of ingredients are selected from an ingredient menu by an end consumer, and wherein the ingredient menu is accessed by the end consumer through a graphical user interface.

18. A multipurpose beverage composition, comprising:
a plurality of ingredients, comprising:
young Thai coconut water;
young Thai coconut meat;
hemp hearts;
Chondrus crispus; and
Medjool dates;
wherein non-liquid ingredients of the plurality of ingredients are combined and blended together for a first amount of time to define a first plurality of blended ingredients, wherein liquid ingredients of the plurality of ingredients are added to the first plurality of blended ingredients and blended together for a second amount of time to define a second plurality of blended ingredients, wherein the second plurality of blended ingredients are filtered through a strainer having a pore diameter of no greater than 0.125 inches.

19. The multipurpose beverage composition of claim 18, wherein the filtered second plurality of blended ingredients are packaged into a thermally robust container.

20. The multipurpose beverage composition of claim 19, wherein the thermally robust container comprises a threaded aperture having dimensions to accept a threaded screw cap of a baby bottle nipple.
